(19) United States
(12) Patent Application Publication
(10) Pub. No.: US 2014/0262424 A1
(43) Pub. Date: Sep. 18, 2014

(54) SHIELDED TWISTED PAIR CABLE

(71) Applicant: DELPHI TECHNOLOGIES, INC., Troy, MI (US)

(72) Inventors: NICOLE L. LIPTAK, CORTLAND, OH (US); JOHN WICKS, CORTLAND, OH (US)

(73) Assignee: DELPHI TECHNOLOGIES, INC., TROY, MI (US)

(21) Appl. No.: 13/804,245

(22) Filed: Mar. 14, 2013

(51) Int. Cl. H01B 11/10

(52) U.S. Cl. CPC H01B 11/10
USPC 174/106 R

(57) ABSTRACT

A wire cable capable of transmitting digital signals with a data rate of at least 5 Gigabits per second (Gb/s). The wire cable includes an insulated twisted pair of conductors and an inner conductive shield enclosing the conductors. The insulation of the twisted pair is bonded to provide consistent spacing between the conductors. A belting formed of a flexible dielectric is disposed between the shield and the bonded twisted pair. The belting provides consistent spacing between the twisted pair and the inner shield. The wire cable further includes a drain wire disposed outside the inner conductive shield and inside an outer conductive shield that encloses both the drain wire and the inner conductive shield. This combination of elements provides a wire cable having consistent impedance that is capable of transmitting digital signals with a data rate of at least 5 Gb/s via a single twisted pair of conductors.

### TECHNICAL FIELD OF INVENTION

The invention generally relates to wire electrical cables, and more particularly relates to a shielded twisted pair cable for transmitting digital electrical signals having a data transfer rate of 5 Gigabits per second (Gb/s) or higher.

### BACKGROUND OF THE INVENTION

The increase in digital data processor speeds has led to an increase in data transfer speeds. Transmission media used to connect electronic components to the digital data processors must be constructed to efficiently transmit the high speed digital signals between the various components. Wired media, such as fiber optic cable, coaxial cable, or twisted pair cable may be suitable in applications where the components being connected are in fixed locations and are relatively close proximity, e.g. separated by less than 100 meters. Fiber optic cable provides a transmission medium that can support data rates of up to nearly 100 Gb/s and is practically immune to electromagnetic interference. Coaxial cable typically supports data transfer rates up to 100 Megabits per second (Mb/s) and has good immunity to electromagnetic interference. Twisted pair cable can support data rates of up to about 5 Gb/s, although these cables typically require multiple twisted pairs within the cable dedicated to transmit or receive lines. The conductors of the twisted pair cables offer good resistance to electromagnetic interference which can be improved by including shielding for the twisted pairs within the cable.

Data transfer protocols such as Universal Serial Bus (USB) 3.0 and High Definition Multimedia Interface (HDMI) 1.3 require data transfer rates at or above 5 Gb/s. Existing coaxial cable cannot support data rates near this speed. Both fiber optic and twisted pair cables are capable of transmitting data at these transfer rates, however fiber optic cables are significantly more expensive than twisted pair, making them less attractive for cost sensitive applications that do not require the high data transfer rates and electromagnetic interference immunity.

Infotainment systems and other electronic systems in automobiles and trucks are beginning to require cables capable of carrying high data rate signals. Automotive grade cables must not only be able to meet environmental requirements (e.g. thermal and moisture resistance), they must also be flexible enough to be routed in a vehicle wiring harness and have a low mass to help meet vehicle fuel economy requirements. Therefore, there is a need for a wire cable with a high data transfer rate that has low mass and is flexible enough to be packaged within a vehicle wiring harness, while meeting cost targets that cannot currently be met by fiber optic cable. Although the particular application given for this wire cable is automotive, such a wire cable would also likely find other applications, such as aerospace, industrial control, or other data communications.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

### BRIEF SUMMARY OF THE INVENTION

In accordance with one embodiment of this invention, a wire cable for transmitting electrical signals is provided. The wire cable includes a central twisted pair of conductors, hereinafter referred to as the twisted pair. Each conductor is enclosed within a dielectric insulator. The insulators are bonded together and run the length of the wire cable. Another dielectric insulator, hereinafter referred to as the belting, encloses the twisted pair. A conductive sheet, hereinafter referred to as the inner shield, encloses the belting. The inner shield is longitudinally wrapped about the belting. A third conductor, hereinafter referred to as the drain wire, is disposed outside of the inner shield, extending generally parallel to the twisted pair and in electrical communication with the inner shield. A braided conductor, hereinafter referred to as the other shield encloses both the inner shield and the drain wire and is in electrical communication with the inner shield and the drain wire. Yet another dielectric insulator, hereinafter referred to as the jacket, encloses the braided conductor. The wire cable is capable of transmitting digital data at a speed of up to 5 Gigabits per second with an insertion loss of less than 20 decibels (dB).

In another embodiment of the present invention, a wire cable for transmitting electrical signals having a single twisted pair of conductors is provided. The wire cable with a single twisted pair of conductors is capable of transmitting digital data at a speed of up to 5 Gigabits per second with an insertion loss of less than 20 decibels (dB).

Further features and advantages of the invention will appear more clearly on a reading of the following detailed description of the preferred embodiment of the invention, which is given by way of non-limiting example only and with reference to the accompanying drawings.

### BRIEF DESCRIPTION OF THE SEVERAL VIEWS OF THE DRAWING

The present invention will now be described, by way of example with reference to the accompanying drawings, in which:

FIG. 1a is perspective cut away drawing of a wire cable in accordance with one embodiment;

FIG. 1b is a cross section drawing of the wire cable of FIG. 1a in accordance with one embodiment;

FIG. 2 is a partial cut away drawing of the wire cable illustrating the twist length of the wire cable of FIG. 1a in accordance with one embodiment;

FIG. 3a is perspective cut away drawing of a wire cable in accordance with another embodiment;

FIG. 3b is a cross section drawing of the wire cable of FIG. 3a in accordance with another embodiment;

FIG. 4a is a perspective cut away drawing of a wire cable in accordance with yet another embodiment;

FIG. 4b is a cross section drawing of the wire cable of FIG. 4a in accordance with yet another embodiment;

FIG. 5 is a cross section drawing of the wire cable of FIG. 4a in accordance with yet another embodiment;

FIG. 6 is a chart illustrating the signal rise time and desired cable impedance of several high speed digital transmission standards;

FIG. 7 is a chart illustrating various performance characteristics of the wire cable of FIG. 2a-4a in accordance with several embodiments; and

FIG. 8 is a graph of the differential insertion loss versus signal frequency of the wire cable of FIGS. 1a-4b in accordance with several embodiments.

### DETAILED DESCRIPTION OF THE INVENTION

Presented herein is a wire cable that is capable of carrying digital signals at rates up to 5 Gigabits per second (Gb/s) (5 billion bits per second). The wire cable includes a twisted pair of conductors to minimize low frequency electromagnetic interference of digital signals carried by the wire cable. The cable also includes a conductive shield to further isolate the conductors from electromagnetic interference. The twisted pair is encased within dielectric belting that helps to provide a consistent radial distance between the twisted pair and the shield and also helps to maintain a consistent twist angle between the conductors of the twisted pair. The consistent radial distance between the twisted pair and the shield and the consistent twist angle provides a wire cable with more consistent impedance.

FIGS. 1a and 1b illustrate a non-limiting example of a wire cable 100 for transmitting electrical digital data signals. The wire cable 100 includes a central twisted pair of conductors comprising a first conductor 102 and a second conductor 104. The first and second conductors 102, 104 are formed of a conductive material with superior conductivity, such as unplated copper or silver plated copper. As used herein, copper refers to elemental copper or a copper-based alloy. Further, as used herein, silver refers to elemental silver or a silver-based alloy. The design, construction, and sources of copper and silver plated copper conductors are well known to those skilled in the art. The first and second conductors 102, 104 may each consist of seven wire strands 106. Each of the wire strands 106 of the first and second conductors 102, 104 may be characterized as having a diameter of 0.12 millimeters (mm), which is generally equivalent to 28 American Wire Gauge (AWG) stranded wire. Alternatively, the first and second conductors 102, 104 may be formed of stranded wire having a smaller gauge, such as 30 AWG or 32 AWG.

As shown in FIG. 2, the central twisted pair of first and second conductors 102, 104 is longitudinally twisted over a length L, for example once every 8.89 mm. Twisting the first and second conductors 102, 104 reduces low frequency electromagnetic interference of the signal carried by the twisted pair.

Referring once more to FIGS. 1a and 1b, each of the first and second conductors 102, 104 are enclosed within a respective first dielectric insulator 108 and a second dielectric insulator 110, hereafter referred to as the first and second insulators 108, 110. The first and second insulators 108, 110 are bonded together. The first and second insulators 108, 110 run the entire length of the wire cable 100, except for portions that are removed at the ends of the cable in order to terminate the wire cable 100. The first and second insulators 108, 110 are formed of a flexible dielectric material, such as polypropylene. The first and second insulators 108, 110 may be characterized as having a thickness of about 0.85 mm.

Bonding the first insulator 108 to the second insulators 110 helps to maintain the spacing between the first and second conductors 102, 104 and keep a twist angle Θ (see FIG. 2) between the first and second conductors 102, 104 consistent. The methods required to manufacture a pair of conductors with bonded insulators are well known to those skilled in the art.

The central twisted pair of first and second conductors 102, 104 and the first and second insulators 108, 110 are completely enclosed within a third dielectric insulator 112, hereafter referred to as the belting 112, except for portions that are removed at the ends of the cable in order to terminate the wire cable 100. The belting 112 is formed of a flexible dielectric material, such as polyethylene. As illustrated in FIG. 1b, the belting may be characterized as having a diameter D of 2.22 mm. A release agent 114, such as a talc-based powder, may be applied to an outer surface of the bonded first and second insulators 108, 110 in order to facilitate removal of the belting 112 from the first and second insulators 108, 110 when ends of the first and second insulators 108, 110 are stripped from the first and second conductors 102, 104 to form terminations of the wire cable 100.

The belting 112 is completely enclosed within a conductive sheet 116, hereafter referred to as the inner shield 116, except for portions that may be removed at the ends of the cable in order to terminate the wire cable 100. The inner shield 116 is longitudinally wrapped in a single layer about the belting 112, so that it forms a single seam 118 that runs generally parallel to the central twisted pair of first and second conductors 102, 104. The inner shield 116 is not spirally wrapped or helically wrapped about the belting 112. The seam edges of the inner shield 116 may overlap, so that the inner shield 116 covers at least 100 percent of an outer surface of the belting 112. The inner shield 116 is formed of a flexible conductive material, such as aluminized biaxially-oriented PET film. Biaxially-oriented polyethylene terephthalate film is commonly known by the trade name MYLAR and the aluminized biaxially-oriented PET film will hereafter be referred to as aluminized MYLAR film. The aluminized MYLAR film has a conductive aluminum coating applied to only one of the major surfaces; the other major surface is non-aluminized and therefore non-conductive. The design, construction, and sources for single-sided aluminized MYLAR films are well known to those skilled in the art. The non-aluminized surface of the inner shield 116 is in contact with an outer surface of the belting 112. The inner shield 116 may be characterized as having a thickness of less than or equal to 0.04 mm.

The belting 112 provides the advantage of maintaining a consistent radial distance between the first and second conductor 104 and the inner shield 116. The belting 112 further provides an advantage of keeping the twist angle Θ of the first and second conductors 102, 104 consistent. Shielded twisted pair cables found in the prior art typically only have air as a dielectric between the twisted pair and the shield. Both the distance between first and second conductors 102, 104 and the inner shield 116 and the effective twist angle Θ of the first and second conductors 102, 104 affect the wire cable impedance. Therefore a wire cable with more consistent radial distance between first and second conductors 102, 104 and the inner shield 116 and a more consistent twist angle Θ of the first and second conductors 102, 104 provides more consistent impedance.

As shown in FIGS. 1a and 1b, the wire cable 100 additionally includes a third conductor 120, hereafter referred to as the drain wire 120 that is disposed outside of the inner shield 116. The drain wire 120 extends generally parallel to the central twisted pair of first and second conductors 102, 104 and is in intimate contact or at least in electrical communication with the aluminized outer surface of the inner shield 116. The drain wire 120 may consist of seven wire strands 122. Each of the wire strands 122 of the drain wire 120 may be characterized as having a diameter of 0.12 mm, which is generally equivalent to 28 AWG stranded wire. Alternatively, the drain wire 120 may be formed of stranded wire having a smaller gauge, such as 30 AWG or 32 AWG. The drain wire 120 is formed of a conductive wire, such as an unplated copper wire or a tin plated copper wire. The design, construction, and sources of copper and tin plated copper conductors are well known to those skilled in the art.

As illustrated in FIGS. 1a and 1b, the wire cable 100 further includes a braided wire conductor 124, hereafter referred to as the outer shield 124, enclosing the inner shield 116 and the drain wire 120, except for portions that may be removed at the ends of the cable in order to terminate the wire cable 100. The outer shield 124 is formed of a plurality of woven conductors, such as copper or tin plated copper. As used herein, tin refers to elemental tin or a tin-based alloy. The design, construction, and sources of braided conductors used to provide wire shields are well known to those skilled in the art. The outer shield 124 is in intimate contact or at least in electrical communication with both the inner shield 116 and the drain wire 120. The wires forming the outer shield 124 may be in contact with at least 65 percent of an outer surface of the inner shield 116. The outer shield 124 may be characterized as having a thickness less than or equal to 0.30 mm.

The wire cable 100 shown in FIGS. 1a and 1b further includes a fourth dielectric insulator 126, hereafter referred to as the jacket 126. The jacket 126 encloses the outer shield 124, except for portions that may be removed at the ends of the cable in order to terminate the wire cable 100. The jacket 126 forms an outer insulation layer that provides both electrical insulation and environmental protection for the wire cable 100. The jacket 126 is formed of a flexible dielectric material, such as cross-linked polyethylene. The jacket 126 may be characterized as having a thickness of about 0.1 mm.

The wire cable 100 is constructed so that the inner shield 116 is tight to the belting 112, the outer shield 124 is tight to the drain wire 120 and the inner shield 116, and the jacket 126 is tight to the outer shield 124 so that the formation of air gaps between these elements is minimized. This provides the wire cable 100 with improved magnetic permeability.

The wire cable 100 may be characterized as having an impedance of 95 Ohms.

The elements shown in FIGS. 3a-5 wherein the last two digits of the reference number correspond to the last two digits reference numbers shown in FIG. 2a perform identical or similar functions as the corresponding elements in the embodiment of FIG. 2a described supra.

FIGS. 3a and 3b illustrate another non-limiting example of a wire cable 200 for transmitting electrical digital data signals. The wire cable 200 illustrated in FIGS. 3a and 3b is identical in construction to the wire cable 100 shown in FIGS. 1a and 1b, with the exception that the central twisted pair of first and second conductors 202, 204 each comprise a solid wire conductor, such as a unplated copper wire or silver plated copper wire having a cross section of about 0.321 square millimeters (mm²), which is generally equivalent to 28 AWG solid wire. Alternatively, the first and second conductors 202, 204 may be formed of a solid wire having a smaller gauge, such as 30 AWG or 32 AWG. The wire cable 200 may be characterized as having an impedance of 95 Ohms.

FIGS. 4a and 4b illustrate another non-limiting example of a wire cable 300 for transmitting electrical digital data signals. The wire cable 300 illustrated in FIGS. 4a and 4b is identical in construction to the wire cable 200 shown in FIGS. 3a and 3b, with the exception that the drain wire 320 comprises a solid wire conductor, such as an unplated copper or tin plated copper conductor having a cross section of about 0.321 mm², which is generally equivalent to 28 AWG solid wire. Alternatively, the drain wire 320 may be formed of solid wire having a smaller gauge, such as 30 AWG or 32 AWG. The wire cable 300 may be characterized as having an impedance of 95 Ohms.

FIG. 5 illustrates yet another non-limiting example of a wire cable 400 for transmitting electrical digital data signals. The wire cable 400 illustrated in FIG. 5 is similar to the construction to the wire cables 100, 200, 300 shown in FIGS. 2a-4b, however, wire cable 400 includes multiple pairs of first and second conductors 402, 404. The belting 412 also eliminates the need for a spacer to maintain separation of the multiple twisted pairs as seen in the prior art for wire cables having multiple twisted pair conductors.

FIG. 6 illustrates the requirements for a wire cable for signal rise time in picoseconds (ps) and differential impedance in Ohms (Ω) for both the USB 3.0 and HDMI 1.3 standards and the combined requirements for a wire cable to meet both standards.

FIG. 7 illustrates the performance characteristics that are expected for wire cables 100, 200, and 300. The wire cables 100, 200, and 300 are expected to meet the combined USB 3.0 and HDMI 1.3 signal rise time and differential impedance requirements shown in FIG. 6.

FIG. 7 illustrates the differential impedances that are expected for wire cables 100, 200, and 300 over a signal frequency range of 0 to 7500 MHz (7.5 GHz).

FIG. 8 illustrates the insertion losses that are expected for wire cables 100, 200, and 300 with a length of 7 m over the signal frequency range of 0 to 7.5 GHz.

Therefore, as shown in FIGS. 7 and 8, the wire cables 100, 200, and 300 having a length of up to 7 meters are expected to be capable of transmitting digital data at a speed of up to 5 Gigabits per second with an insertion loss of less than 20 dB.

Accordingly, a wire cable 100, 200, 300, and 400 is provided. The wire cable 100, 200, 300, 400 is capable of transmitting digital data signals with data rates of 5 Gb/s or higher. The wire cable 100, 200, 300 is capable of transmitting signals at this rate over a single twisted pair of conductors rather than multiple twisted pairs as used in other high speed cables capable of supporting similar data transfer rates, such as Category 7 cable. Using a single twisted pair as in wire cable 100, 200, 300 provides the advantage of eliminating the possibility for cross talk as occurs between twisted pairs in other wire cables having multiple twisted pairs. The single twisted pair in wire cable 100, 200, 300 also reduces the mass of the wire cable 100, 200, 300, something that is important in weight sensitive applications such as automotive and aerospace. The belting 112, 212, 312, 412 between the first and second conductors 102, 202, 302, 402, 104, 204, 304, 404 and the inner shield 116, 216, 316, 416 helps to maintain a consistent radial distance between the first and second conductors 102, 202, 302, 402, 104, 204, 304, 404 and the inner shield 116, 216, 316, 416, especially when the cable is bent as is required in routing the wire cable 100, 200, 300, 400 within an automotive wiring harness assembly. Maintaining the consistent radial distance between the first and second conductors 102, 202, 302, 402, 104, 204, 304, 404 and the inner shield 116, 216, 316, 416 provides for a consistent cable impedance and more reliable data transfer rates. The belting 112, 212, 312, 412 and the bonding of the first and second insulators 108, 208, 308, 408, 110, 210, 310, 410 helps to maintain the twist angle Θ between the first and second conductors 102, 202, 302, 402, 104, 204, 304, 404 in the twisted pair, again, especially when the cable is bent. This also provides consistent cable impedance. Therefore, it is a combination of the elements, such as the bonding of the first and second insulators 108, 208, 308, 408, 110, 210, 310, 410 and the belting 112, 212, 312, 412, the inner shield 116, 216, 316, 416 and not any one particular element that provides a wire cable 100, 200, 300, 400 having consistent impedance that is capable of transmitting digital data at a speed of 5 Gb/s or more, even when the wire cable 100, 200, 300, 400 is bent.

While this invention has been described in terms of the preferred embodiments thereof, it is not intended to be so limited, but rather only to the extent set forth in the claims that follow. Moreover, the use of the terms first, second, etc. does not denote any order of importance, but rather the terms first, second, etc. are used to distinguish one element from another. Furthermore, the use of the terms a, an, etc. do not denote a limitation of quantity, but rather denote the presence of at least one of the referenced items.

1. A wire cable comprising:
a central twisted pair of first and second conductors, each at least partially enclosed within a respective first and second dielectric insulators that are bonded together and running the length of the wire cable;
a third dielectric insulator at least partially enclosing the first and second dielectric insulators;
a conductive sheet at least partially enclosing the third dielectric insulator, wherein the conductive sheet is longitudinally wrapped about the third dielectric insulator and wherein the third dielectric insulator provides consistent radial spacing between the conductive sheet and the central twisted pair of first and second conductors;
a third conductor outside of the conductive sheet, extending generally parallel to the central twisted pair of first and second conductors and in electrical communication with the conductive sheet;
a braided conductor at least partially enclosing the conductive sheet and the third conductor and in electrical communication with the conductive sheet and the third conductor; and
a fourth dielectric insulator at least partially enclosing the braided conductor, thereby the wire cable having a length of at least 7 meters is capable of transmitting digital data at a speed of up to 5 Gigabits per second with an insertion loss of less than 20 dB.

2. The wire cable according to claim 1, wherein the first conductor and the second conductor are formed of copper.

3. The wire cable according to claim 2, wherein the first conductor consists of seven wire strands and the second conductor consists of seven wire strands.

4. The wire cable according to claim 3, wherein each of the wire strands of the first conductor and the second conductor are characterized as having a diameter of 0.12 millimeters (mm).

5. The wire cable according to claim 2, wherein the first conductor and the second conductor comprise a solid wire conductor having a cross section of about 0.321 square millimeters (mm²).

6. The wire cable according to claim 1, wherein the third conductor is formed of copper.

7. The wire cable according to claim 6, wherein the third conductor consists of seven wire strands.

8. The wire cable according to claim 7, wherein each of the wire strands of the third conductor are characterized as having a diameter of 0.12 mm.

9. The wire cable according to claim 6, wherein the third conductor consists of a solid wire conductor having a cross section of about 0.321 square millimeters (mm²).

10. The wire cable according to claim 1, wherein the central twisted pair of first and second conductors is longitudinally twisted once every 8.89 mm.

11. The wire cable according to claim 1, wherein the first and second dielectric insulators are formed of polypropylene.

12. The wire cable according to claim 1, wherein the third dielectric insulator is formed of polyethylene.

13. The wire cable according to claim 12, wherein the third dielectric insulator is characterized as having a diameter of 2.22 mm.

14. The wire cable according to claim 1, wherein the conductive sheet covers at least 100 percent of an outer surface of the third dielectric insulator.

15. The wire cable according to claim 14, wherein the conductive sheet is formed of aluminized film.

16. The wire cable according to claim 15, wherein a non-aluminized surface of the aluminized film is in contact with the outer surface of the third dielectric insulator.

17. The wire cable according to claim 15, wherein the conductive sheet is characterized as having a thickness less than or equal to 0.04 mm.

18. The wire cable according to claim 1, wherein the braided conductor is formed of tin plated copper.

19. The wire cable according to claim 18, wherein the braided conductor is in contact with at least 65 percent of an outer surface of the conductive sheet.

20. The wire cable according to claim 19, wherein the braided conductor is characterized as having a thickness less than or equal to 0.30 mm.

21. The wire cable according to claim 1, wherein the fourth dielectric insulator is formed of cross linked polyethylene.

22. The wire cable according to claim 21, wherein the fourth dielectric insulator is characterized as having a thickness of 0.1 mm.

23. The wire cable according to claim 1, wherein a release agent is applied to an outer surface of the bonded first and second dielectric insulators.

24. The wire cable according to claim 1, wherein the wire cable is characterized as having an impedance of 95 Ohms.

25. The wire cable according to claim 1, wherein the wire cable having a length of up to 7 meters is characterized as having a differential insertion loss of less than 1.5 decibels (dB) for a signal with signal content less than 100 Megahertz (MHz), less than 5 dB for a signal with signal content between 100 MHz and 1.25 Gigahertz (GHz), less than 7.5 dB for a signal with signal content between 1.25 GHz and 2.5 GHz, and less than 25 dB for a signal with signal content between 2.5 GHz and 7.5 GHz.

26. The wire cable according to claim 1, wherein the wire cable is characterized as having an inter-pair skew of less than 15 picoseconds per meter.

27. The wire cable according to claim 1, wherein the wire cable is characterized as having dielectric strength of at least 0.5 kilovolts/minute.

28. The wire cable according to claim 1, wherein the wire cable is characterized as having a direct current resistance less than or equal to 381 Watts/kilometer at 20° C.

29. The wire cable according to claim 1, wherein the wire cable is characterized as having a bending radius of less than 31 mm.

30. A wire cable consisting of:
a single twisted pair of first and second conductors, each at least partially enclosed within respective first and second dielectric insulators that are bonded together and running the length of the wire cable;
a release agent applied to an outer surface of the bonded first and second dielectric insulators;
a third dielectric insulator at least partially enclosing the first and second dielectric insulators;
a conductive sheet at least partially enclosing the third dielectric insulator, wherein the conductive sheet is longitudinally wrapped about the third dielectric insulator and wherein the third dielectric insulator provides consistent radial spacing between the conductive sheet and the central twisted pair of first and second conductors;
a third conductor outside of the conductive sheet, extending generally parallel to the single twisted pair of first and second conductors and in electrical communication with the conductive sheet;
a braided conductor at least partially enclosing the conductive sheet and the third conductor and in electrical communication with the conductive sheet and the third conductor; and
a fourth dielectric insulator at least partially enclosing the braided conductor, thereby the wire cable having a length of at least 7 meters is capable of transmitting digital data at a speed of up to 5 Gigabits per second with an insertion loss of less than 20 dB.
